(19) United States
(12) Patent Application Publication
(10) Pub. No.: US 2006/0077189 A1
(43) Pub. Date: Apr. 13, 2006

(54) Method and apparatus for monitoring software components

(75) Inventor: Paul Michael Merrison, Berkshire (GB)

Correspondence Address: HARRINGTON & SMITH, LLP, 4 RESEARCH DRIVE, SHELTON, CT, 06484-6212, US

(73) Assignee: International Business Machines Corporation

(21) Appl. No.: 11/224,646

(22) Filed: Sep. 12, 2005

(30) Foreign Application Priority Data
Sep. 15, 2004 (GB) 0420470.7

(51) Int. Cl. G09G 5/00

(52) U.S. Cl. 345/179

(57) ABSTRACT

A method and apparatus is disclosed for gathering data on the software or firmware levels of devices in a computer system to enable the management and maintenance of the system.

### FIELD OF THE INVENTION

The present invention relates to a method and apparatus for monitoring software components. More particularly, but not exclusively, the present invention relates to managing the versions of software installed on machines connected over a network.

### BACKGROUND

Computer systems comprise software and hardware which is periodically modified and updated with new versions. Different versions of hardware or software may interact differently with other parts of the computer system. For example, a new version of an operating software system may not support application programs run on older versions of the operating system, causing the applications to malfunction or not even run at all. As a result, it is important that an accurate record of the software and hardware levels of the elements of a computer system is maintained in order to manage the system efficiently.

Management systems can be installed which collect and store data on the software and hardware to enable the integrity of the computer system to be maintained. US 2001/0056386 discloses a software and hardware component audit and inventory management system in which inventory agent software is installed on each computer being managed. The inventory agent responds to a message from the central control system to make an inventory of the software and hardware of the computer and returns the inventory to the central system. The inventory can then be used in the management of updates to the software and hardware of the computer system.

U.S. Pat. No. 6,425,126 discloses a software synchronizing system which issues software updates to software update controllers which are installed on each computer in a network of computers. The software updates are arranged to bring the software on each computer to the same level, that is, to synchronize the software across the network. The software update may include elements which are already installed on a given computer or may stipulate the removal of elements which are not present on a given computer. The update controller processes the software update and installs or removes only the applicable software elements.

A drawback of the above systems is that they require custom software to be installed on and run on each computer being managed in order for the systems to operate.

It is an object of the present invention to provide a system for monitoring software components, which avoids some of the above disadvantages or at least provides the public with a useful choice.

### SUMMARY OF THE INVENTION

An aspect of this invention pertains to a method to monitor software components on a device comprising: selecting a device and retrieving a device identifier for the device; determining a software component to be monitored on the device; creating an instruction native to the device for determining management data for the software component on the device and transmitting a message comprising the device identifier and the instruction to the selected device.

Another aspect of this invention pertains to a computer program product that comprises a computer useable medium including a computer readable program, where the computer readable program when executed on a computer causes the computer to select a device and retrieve a device identifier for the device; determine a software component to be monitored on the device; create an instruction native to the device for determining management data for the software component on the device and transmit a message comprising the device identifier and the instruction to the selected device. A still further aspect of this invention pertains to apparatus for collecting software version data from a networked computer and an associated hardware element. The apparatus comprises a network connection for opening a connection to the computer; a processor operable if the software version data of software on the computer is required to issue a native command to the computer for providing the data; and where the processor is further operable if the software version data of software on the associated device is required to issue a native command to the computer to cause the computer to interrogate the associated device and to retrieve the data.

### BRIEF DESCRIPTION OF THE DRAWINGS

Embodiments of the invention will now be described, by way of example only, with reference to the accompanying drawings in which:

FIG. 1 is a schematic illustration of a network of computers including a client and server computers of a software management system;

FIGS. 2a, 2b and 2c are a set of tables showing the data used and produced by the software management system of FIG. 1;

FIG. 3 is a flow chart illustrating the processing of a client computer of FIG. 1; and

FIG. 4 is a flow chart illustrating the processing of a server computer of FIG. 1.

### DETAILED DESCRIPTION

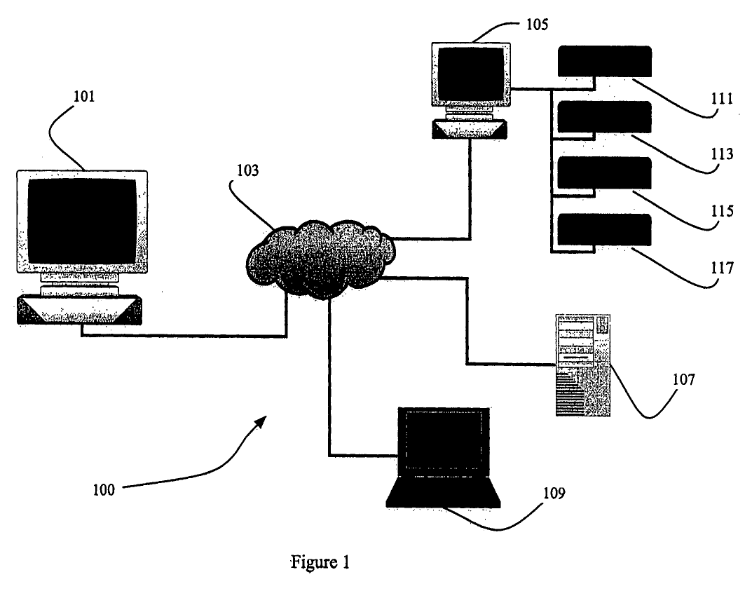

FIG. 1 shows a computer system 100 comprising a client computer 101 connected over a network 103 to three server computers 105, 107, 109. The client computer 101 is running the Linux™ operating system, the first server 105 is running the AIX™ operating system, the second server is running the Solaris™ operating system and the third server is running the Windows™ operating system. The first server computer 105 is also connected to four peripheral devices in the form of two Brocade™ Fibre Channel SAN (Storage Area Network) switches 111, 113 and two FastT™ RAID (Redundant Array of Independent Disks) disk controllers 115, 117, all installed with their associated firmware.

The client and server computers 101, 105, 107, 109 can communicate with each other via connections made over the network 103. The peripheral devices in the form of the switches 111, 113 and controllers 115, 117 cannot make network connections and can only communicate with the first server computer 105, which provides a management interface utility to the switches 111, 113, and controllers 115, 117.

In addition to the operating systems noted above, each of the devices attached to the network is also installed with additional software such as hardware driver programs, firmware and application programs. The software, including the operating systems, exists in numerous different versions resulting from updates and patches that may have been installed. Without checking the software or firmware as installed on any given device it is difficult to determine the actual versions of software or firmware being used. Such version information or management data on the state of the software and firmware is important for monitoring the software and firmware components for the efficient management of the computer system 100.

The client computer 101 runs a software management system which gathers management data on the state of the software and firmware for all the elements of the network 100 including the peripherals 111, 113, 115, 117. The client computer 101 can operate in either an interactive mode or a batch mode. The software management system is designed so that most of the complexity is present in the client software rather than in the server software. This means that any changes are most likely to be implemented on the client computer 101, thereby reducing the need to update every server computer 105, 107, 109 deployed on the network.

In the interactive mode, the client software provides a graphical user interface GUI which enables a user to specify which of the server computers 105, 107, 109 they wish to gather data from. The GUI also enables the user to specify what information they want to retrieve from a specified network element or device. For example, from an AIX™ host, the user may want to know the base operating system level or the firmware version of attached hardware. Once this specification is entered, it can be saved to a configuration file, so that the user does not have to re-enter it during future sessions.

The user then starts the data gathering process and the client computer 101 opens network connections- to the specified server computers as described in further detail below. When the data collection is complete, the results are presented to the user, and can be saved to a file for importing into a spreadsheet program such as Lotus 1-2-3™ or Microsoft Excel™ for further processing.

In the batch mode the client software automatically reads one or more configuration files saved by a user as noted above and gathers the data defined by the file. It is also possible for the user to create the configuration file using a text editor. The results of a batch mode data gathering process are saved in a file for importing into a spreadsheet program as noted above for further processing.

Each server computer 105, 107, 109 acts as a server in the software management system. When the server receives a request from the client, a command or script is run on the server operating system to gather the information requested. The gathered information is then returned to the client. The peripheral devices 111, 113, 115, 117 cannot communicate independently over the network and therefore data is gathered from them through the server computer 105 acting as a proxy server. The proxy server relationship is defined in both the client and server software. When data is to be gathered from a peripheral, a request which includes a host identifier for the peripheral is sent to the proxy server. When the proxy server receives a request for information with a host identifier that does not match its own, it queries the identified device accordingly via the existing management interface utility. The information is then returned to the client as if it were the peripheral device itself returning the information.

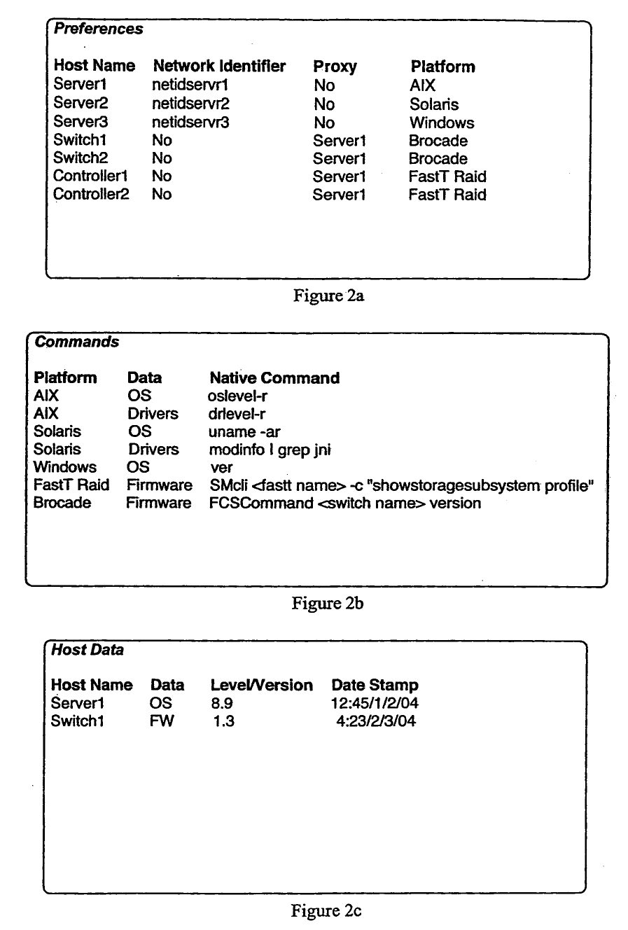

The software management system client program running on the client computer 101 holds two sets of data as shown in the tables of FIGS. 2a and 2b. The data in the tables is used by the client to create the data requests sent to the server computers. The preferences table in FIG. 2a lists each server in the network by network identifier, the associated proxy server if applicable and the command language used by the element. If the element is accessed via a proxy, the network identifier of the proxy is listed, but no network identifier exists for the element itself. The data requests table shown in FIG. 2b lists all of the possible data requests that can be made for each server platform used in the network, along with the native command for the given platform. Where a data request needs to be made via a proxy server, the native command is embedded in a command for the management interface utility existing on the server. The command for the management interface is native to the server. Examples of such embedded commands are shown on the entries for the FastT™ RAID and Brocade™ platforms in FIG. 2b.

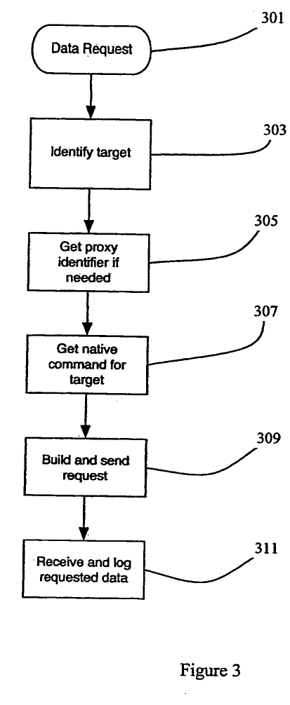

The processing of a data request by the client computer 101 will now be described with reference to the flow chart of FIG. 3. At step 301 the data request is triggered, either by the user via the GUI or by a batch mode operation, and processing moves to step 203. The generated request messages have the following format:
<Hostname>,<Platform>,<Data required>.

For example, a request for the operating system version of the AIX™ server 105 called Server1 would take the form:
Server1, AIX, OS.

At step 303, the preferences table is used to identify the target of the data request and to retrieve the network identifier for the server and processing moves to step 305. At step 305 the preferences table is inspected to determine if the network element or device is accessed via a proxy server and if so the network identifier of the proxy server is retrieved. Processing then moves to step 307 where the native command is retrieved which will return the requested data. Processing then moves to step 309 where the translated request to be sent to the target server computer is assembled and sent to the server with the corresponding network identifier. The translated requests have a standard format as follows:
<Host Network Identifier>,<Host Name>,<Native Command>.

For example, the above request for the operating system version of the AIX™ server 105 named Server1 would be translated into the following request which is then transmitted to the server:
Netidserv1, Server1, oslevel-r.

In a translated request where the target device or element uses a proxy server, the network identifier for the proxy server is entered as the host network identifier and the host name is that of the target device. For example, a user request for the firmware level of the Brocade™ switch 111 attached to the server 105 would have the form:
Switch1, Brocade, FW.

This request would be translated into the following request:
Netidserv1, Switch1, FCSCommand Switch1 version.

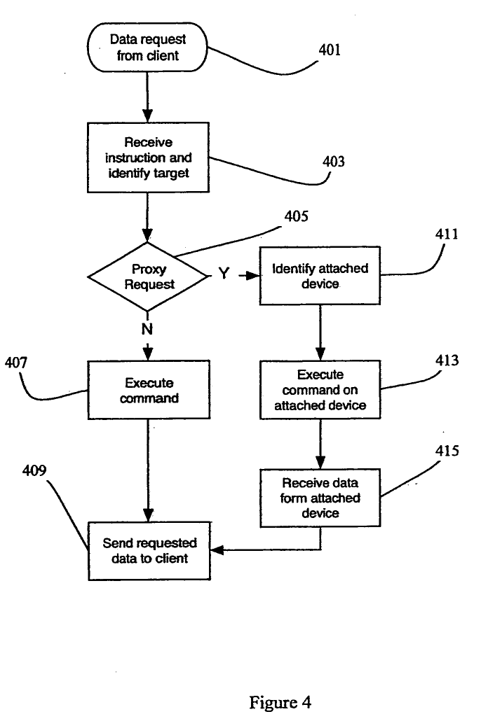

The processing of a request by a server will now be described with reference to the flowchart of FIG. 4 in which at step 401 the request is received over the network and processing moves to step 403 where the target host is identified. At step 405 the target host is compared to the current server name. If they are the same then the server is not acting as a proxy server and processing moves to step 407 where the native command from the request is executed in the target host operating system. Once the command execution is complete, the results are returned to the client computer 101 over the network 103.

If at step 405, the target host name is not that of the current server name then processing moves to step 411 where the target host is matched to an attached device. If no such attached device is matched then an error message is issued to the client and processing ends. If a positive match is made then processing then moves to step 413 where the native command from the request is executed for the attached device. Once the command execution is complete, processing moves to step 315 where the resulting data is returned to the proxy server and processing moves to step 409 where the proxy server sends the requested data to the client as if it had originated from the attached device itself.

Returning to FIG. 3, when the requested data is received by the client it is logged in a file. An example of logged data is shown in FIG. 2c. The request described above for the operating system level of the AIX™ server 105 results in the first line of the table which identifies the host name, the software or firmware on which data was requested, the version or level of that software and a date stamp for the request. This data can then be used by a network administrator to maintain the software or firmware levels within the computer network. In addition, the data in the table of FIG. 2c can be interfaced to an automated software updating system arranged to maintain the various platforms at defined levels.

It will be understood by those skilled in the art that the apparatus that embodies a part or all of the present invention may be a general purpose device having software arranged to provide a part or all of an embodiment of the invention. The device could be single device or a group of devices and the software could be a single program or a set of programs. Furthermore, any or all of the software used to implement the invention can be communicated via various transmission or storage means such as computer network, floppy disc, CD-ROM or magnetic tape so that the software can be loaded onto one or more devices.

In view of the foregoing description when read in light of the appended drawings it can be appreciated that according to a first aspect of the invention there is provided a method for monitoring software components on a device comprising selecting a device and retrieving a device identifier for the device; determining a software component to be monitored on the device; creating an instruction native to the device for determining management data for the software component on the device; and transmitting a message comprising the device identifier and the instruction to the selected device.

Preferably, if the device is not capable of receiving the message then the message is sent to a proxy computer capable of receiving the message and in communication with the device. Preferably, a group of hardware elements are monitored and the group comprises hardware elements running different operating system software. Preferably, a group of devices are monitored and the group comprises devices running different versions of a software system or application. Preferably, the message sent to the proxy computer includes the identifier of the device to indicate to the proxy computer that the instruction in the message is to be applied to the connected device. Preferably, the transmitted instruction is saved in a batch file for subsequent periodic monitoring of the software components. Preferably, the management data received from the device in response to the native instruction is stored for use by a software update system.

According to a second aspect of the invention there is provided apparatus for monitoring software components on a device comprising means for selecting a device and retrieving a device identifier for the device; means for determining a software component to be monitored on the device; means for creating an instruction native to the device for determining management data for the software component on the device; and means for transmitting a message comprising the device identifier and the instruction to the selected device.

According to a third aspect of the invention there is provided a computer program or suite of computer programs arranged to enable a computer or group of computers to carry out a method for monitoring software components on a device comprising selecting a device and retrieving a device identifier for the device; determining a software component to be monitored on the device; creating an instruction native to the device for determining management data for the software component on the device; and transmitting a message comprising the device identifier and the instruction to the selected device.

According to a fourth aspect of the invent there is provided a computer program or suite of computer programs arranged to enable a computer or group of computers to provide apparatus for monitoring software components on a device comprising means for selecting a device and retrieving a device identifier for the device; means for determining a software component to be monitored on the device; means for creating an instruction native to the device for determining management data for the software component on the device; and means for transmitting a message comprising the device identifier and the instruction to the selected device.

According to a further aspect of the invention there is provided a method of collecting software version data from a networked computer and an associated hardware element, the method comprising opening a connection to the computer; if the software version data of software on the computer is required then issuing a native command to the computer for providing the data; and if the software version data of software on the associated device is required then issuing a native command to the computer to cause the computer to interrogate the associated device and to retrieve the data. Preferably the native command to the computer comprises an embedded native command for the associated device.

According to a still further aspect of the invention there is provided apparatus for collecting software version data from a networked computer and an associated hardware element, where the apparatus comprises a network connection for opening a connection to the computer; a processor operable if the software version data of software on the computer is required to issue a native command to the computer for providing the data; and the processor being further operable if the software version data of software on the associated device is required to issue a native command to the computer to cause the computer to interrogate the associated device and to retrieve the data.

While the present invention has been illustrated by the description of the embodiments thereof, and while the embodiments have been described in detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the scope of applicant's general inventive concept.

What is claimed is:

1. A method to monitor software components on a device comprising:
selecting a device and retrieving a device identifier for the device;
determining a software component to be monitored on the device;
creating an instruction native to the device for determining management data for the software component on the device; and
transmitting a message comprising the device identifier and the instruction to the selected device.

2. A method according to claim 1 in which if the device is not capable of receiving the message then the message is sent to a proxy computer capable of receiving the message and in communication with the device.

3. A method according to claim 1 in which a group of hardware elements are monitored and the group comprises hardware elements running different operating system software.

4. A method according to claim 1 in which a group of devices are monitored and the group comprises devices running different versions of a software system or application.

5. A method according to claim 2 in which the message sent to the proxy computer includes the identifier of the device to indicate to the proxy computer that the instruction in the message is to be applied to the connected device.

6. A method according to claim 1 in which the transmitted instruction is saved in a batch file for subsequent periodic monitoring of the software components.

7. A method according to claim 1 in which the management data received from the device in response to the native instruction is stored for use by a software update system.

8. A computer program product comprising a computer useable medium including a computer readable program, where the computer readable program when executed on a computer causes the computer to:
select a device and retrieve a device identifier for the device;
determine a software component to be monitored on the device;
create an instruction native to the device for determining management data for the software component on the device; and
transmit a message comprising the device identifier and the instruction to the selected device.

9. A computer program product as in claim 8 in which if the device is not capable of receiving the message then the message is sent to a proxy computer capable of receiving the message and in communication with the device.

10. A computer program product as in claim 8 where the computer readable program when executed on a computer further causes the computer to monitor a group of hardware elements comprising hardware elements running different operating system software.

11. A computer program product as in claim 8 where the computer readable program when executed on a computer further causes the computer to monitor a group of devices comprising devices running different versions of a software system or application.

12. A computer program product as in claim 9 in which the message sent to the proxy computer includes the identifier of the device to indicate to the proxy computer that the instruction in the message is to be applied to the connected device.

13. A computer program product as in claim 8 where the computer readable program when executed on a computer further causes the computer to save in a batch file the transmitted instruction for subsequent periodic monitoring of the software components.

14. A computer program product as in claim 8 where the computer readable program when executed on a computer further causes the computer to store management data received from the device in response to the native instruction for use by a software update system.

15. A computer program product as in claim 8 where the computer, when determining the software component to be monitored on the device and creating an instruction native to the device reads data from a data set that comprises data descriptive at least of a type of platform associated with the device and a native instruction associated with the platform for determining the management data for the software component on the device.

16. A computer program product as in claim 15 where the data set further comprises data descriptive of at least a network address associated with the device and, for a case where the device does not have a network address, an identification of a proxy through which the device can be contacted.

17. Apparatus for collecting software version data from a networked computer and an associated hardware element, the apparatus comprising:
a network connection for opening a connection to the computer;
a processor operable if the software version data of software on the computer is required to issue a native command to the computer for providing the data; and
the processor being further operable if the software version data of software on the associated device is required to issue a native command to the computer to cause the computer to interrogate the associated device and to retrieve the data.

18. Apparatus as in claim 17 in which a native command for the associated device is embedded in the native command for the computer.

19. Apparatus according to claim 17 in which the device comprises a Storage Area Network (SAN) switch.

20. Apparatus according to claim 17 in which the device comprises a Redundant Array of Independent Disks (RAID) controller.
